(19) United States
(12) Patent Application Publication
(10) Pub. No.: US 2025/0109600 A1
(43) Pub. Date: Apr. 3, 2025

(54) Fixture and Construction Method Suitable for Installation and Uninstallation of Large Steel Structures

(71) Applicant: CHINA MCC5 GROUP CORP. LTD., Chengdu, Sichuan (CN)

(72) Inventors: Zhihua LIU, Chengdu, Sichuan (CN); Qihou TAN, Chengdu, Sichuan (CN); Xu CHENG, Chengdu, Sichuan (CN); Ping YAO, Chengdu, Sichuan (CN); Tong ZHOU, Chengdu, Sichuan (CN); Yongshuai LI, Chengdu, Sichuan (CN); Jiujun LI, Chengdu, Sichuan (CN); Jiaming SHU, Chengdu, Sichuan (CN)

(21) Appl. No.: 18/728,160

(22) PCT Filed: Jun. 25, 2023
(86) PCT No.: PCT/CN2023/102037

§ 371 Date: Jul. 11, 2024

(30) Foreign Application Priority Data
Jul. 6, 2022 (CN) 202210788521.2

(51) Int. Cl. E04G 21/18

(52) U.S. Cl. CPC E04G 21/1841

(57) ABSTRACT

A fixture and a construction method suitable for installation and uninstallation of large steel structures are provided. The fixture has a limit adapter component used to support and fix steel structures, a spherical sliding device connected with the limit adapter component, a locking device provided with an arc-shaped groove, an inclined strut whose two ends are hinged with the locking device and the spherical sliding device respectively, a jacking mechanism installed at the bottom of the locking device, and a gasket adjustment unit located outside the jacking mechanism and abutted with the bottom of the locking device.

### TECHNICAL FIELD

The present invention relates to the field of steel structure construction technology, and more specifically, to a fixture and a construction method suitable for installation and uninstallation of large steel structures.

### BACKGROUND

During the construction process of large steel structures, lifting segment by segment or overall lifting is often used for installation. After lifting to the installation position, the large steel structures and components face the problem of precise installation and safe uninstallation on the support frame.

At present, the precise installation of steel structures or components is often performed by welding limit plates on the support frame. After the steel structures or components are lifted in place, the falling direction of the steel structure or component is controlled by manual pushing, pulling, twisting, etc., and the limit plate clamps welded on the support frame are used to limit the falling trajectory of the steel structure, achieving the installation of the component from the lifting state to the assembly state. Although this construction method is adjusted multiple times in the air before falling, it is often difficult to achieve accurate positioning of the steel structure or component during actual construction. At the same time, this method requires a lot of manpower and often operates on high-altitude support frames with confined operating space, which poses significant safety risks during construction. At the same time, after the steel structures are assembled, it involves the safe uninstallation of large-span complex steel structures from the support frame. Currently, the method of uninstalling steel structures is often a cutting plate method, which requires cutting the support steel plate according to the calculated displacement, resulting in slower construction efficiency.

### SUMMARY

The technical problem to be solved by the present invention is to provide a fixture and a construction method suitable for installation and uninstallation of large steel structures, which can effectively achieve precise installation and uninstallation of steel structures and their components, with a simple structure and strong practicality.

The solution adopted to solve the technical problem in the present invention is:

A fixture suitable for installation and uninstallation of large steel structures, comprising a limit adapter component used to support and fix steel structures, a spherical sliding device connected with the limit adapter component, a locking device provided with an arc-shaped groove, an inclined strut whose two ends are hinged with the locking device and the spherical sliding device respectively, a jacking mechanism installed at the bottom of the locking device, and a gasket adjustment unit located outside the jacking mechanism and abutted with the bottom of the locking device.

In use, the steel structures are first connected with the limit adapter component, and the spherical sliding device is connected with the bottom of the limit adapter component; the above connecting structure is lifted to the designated position of the locking device, and the spherical sliding device is controlled to move into the arc-shaped groove, and move in the arc-shaped groove to the bottom position of the arc-shaped groove; when the device is stable, the spherical sliding device and locking device are hinged through the inclined strut, in order to achieve temporary fixation;

After the steel structure is assembled, the bottom of the locking device will be jacked by a jacking mechanism during each stage of uninstallation, so that the locking device moves towards the side away from the gasket adjustment unit, achieving separation between the two; according to the uninstallation amount at each point, the corresponding gasket adjustment unit is replaced, and the jacking mechanism is controlled to fall back; after safety is confirmed, the next unstallation step is performed until the uninstallation is completed.

In some possible implementations, in order to effectively realize installation of steel structures,
the limit adapter component comprises an installation component used to install steel structures, and a connecting web plate used to connect with the installation component.

In some possible implementations, in order to effectively realize sliding fit between the spherical sliding device and the arc-shaped groove, and reduce the sliding friction force,
the spherical sliding device comprises an adapter plate connected with the limit adapter component, an ear plate installed on the adapter plate and hinged with the inclined strut, and a sliding ball connected with the end of the ear plate away from the adapter plate.

In some possible implementations, in order to effectively realize connection between the inclined strut and the locking device,
the locking device comprises a locking body with an arc-shaped groove and a connecting lug arranged outside the locking body; and the end of the inclined strut far from the spherical sliding device is hinged with the connecting lug.

In order to effectively limit the position of the sliding ball end in the arc-shaped groove and avoid sliding after assembly,
the arc-shaped groove is a spherical crown groove, and a limit groove is provided at the bottom of the arc-shaped groove.

In some possible implementations, in order to effectively realize temporary fixation between the spherical sliding device and the locking device,
there are multiple sets of inclined struts, and the connecting lug is provided with a support lug hinged with the inclined strut; the inclined strut comprises an upper lead screw hinged with the ear plate, a lower lead screw connected with the support lug, and sleeves connected with the upper lead screw and the lower lead screw respectively; threads are provided outside the upper lead screw and the lower lead screw, and the two sets of threads rotate in opposite directions.

In some possible implementations, in order to effectively realize uninstallation,
the gasket adjustment unit comprises a support platform, an installation part installed on the support platform and provided with an installation groove, multiple sets of stacked gaskets with different thicknesses, and a support adapter installed above the gasket and connected with the connecting lug; the gasket is installed in the installation groove.

In some possible implementations, in order to support steel structures more stably,
there are multiple sets of the support adapters, connecting lugs, and installation parts, provided one-to-one correspondingly; an installation chamber is formed inside the multiple set of installation parts for installing the jacking mechanism.

On the other hand:

A construction method of a fixture suitable for installation and uninstallation of large steel structures specifically comprises the following steps:
step S1: connecting steel structures with the limit adapter component;
step S2: lifting, and positioning the spherical sliding device in the arc-shaped groove, temporarily fixing the spherical sliding device and locking device through the inclined strut, and assembling the steel structures;
step S3: uninstallation;
step S31: jacking the locking device upwards by the jacking mechanism and driving steel structures to move upwards, and removing the gasket according to the uninstallation amount;
step S32: controlling the jacking mechanism to drive the steel structures downwards and continuing to unload until the uninstallation is completed.

In some possible implementations, the step S2 specifically comprises the following steps:
step S21: lifting, controlling the sliding ball to slide in the arc-shaped groove, and sliding into the limit groove;
step S22: twisting the sleeve and adjusting the position relationship between the upper lead screw and the lower lead screw to temporarily fix the spherical sliding device and locking device; and
step S23: assembling the steel structures.

Compared with the prior art, the beneficial effects of the present invention are:

The present invention achieves automatic and precise positioning of large steel structures through the coordination of spherical sliding devices and locking devices, relying on the gravity of structural components, greatly reducing manual labor and lowering the safety risks of high-altitude operations;

The present invention is designed for different steel structural components, and only requires processing or adjustment of the limit adapter device, with the purpose of being reusable multiple times;

The present invention has a simple structure and strong practicality.

### BRIEF DESCRIPTION OF THE DRAWINGS

FIG. 1 is a structural diagram of the present invention;

FIG. 2 is a structural diagram of the spherical sliding device in the present invention;

FIG. 3 is a structural diagram of the locking device in the present invention;

FIG. 4 is a structural diagram of the limit groove B, locking body, and the connecting lug in the present invention;

FIG. 5 is a structural diagram of the inclined strut in the present invention;

FIG. 6 is a structural diagram of the support platform, installation component in the present invention;

FIG. 7 is a structural diagram of the support adapter in the present invention;

FIG. 8 is a structural diagram of the gasket in the present invention; and

FIG. 9 is a schematic diagram of the connection relationship among the installation components, connecting web plates, and the steel structures when the steel structures are inclined in the present invention;

In which: 100. steel structure; 1. limit adapter component; 2. spherical sliding device; 21. adapter plate; 22. ear plate; 23. sliding ball; 3. locking device; 31. arc-shaped groove; 311. limit groove; 312. limit groove B; 32. connecting lug; 321. support lug; 4. inclined strut; 41. upper lead screw; 411. pin roll; 42. sleeve; 421. handle; 43. lower lead screw; 5. jacking mechanism; 6. gasket adjustment unit; 61. support platform; 611. limit groove A; 62. installation part; 621. installation groove; 63. support adapter. 64. gasket.

### DETAILED DESCRIPTION OF THE PREFERRED EMBODIMENTS

In the present invention, unless otherwise specified and defined explicitly, the terms “installation”, “linking”, “connection” and “fixing” shall be comprehend in a broad sense, for example, it can be fixed connection, and can also be removable connection, or integrated; can be direct linking, and can be indirect linking through an intermediary, or connection in two elements or interaction with each other between two element. The terms “first,” “second,” and the like as mentioned in this application do not denote any order, quantity, or importance, but are used only to distinguish different components. Similarly, the terms “one” or “one piece” do not indicate a quantitative limitation, but the presence of at least one. In the present embodiment, the term “and/or” in this application describes an association relationship for describing associated objects and represents that three relationships may exist. For example, A and/or B may represent the following three cases: Only A exists, both A and B exist, and only B exists. In the description of the present embodiment, “multiple” means two or more, unless otherwise specified. For example, multiple registration masts refer to two or more registration masts. For an ordinary person skilled in the art, the specific implications of the above terms in the present invention may be comprehended in accordance with specific conditions.

Below is a detailed explanation of the present invention.

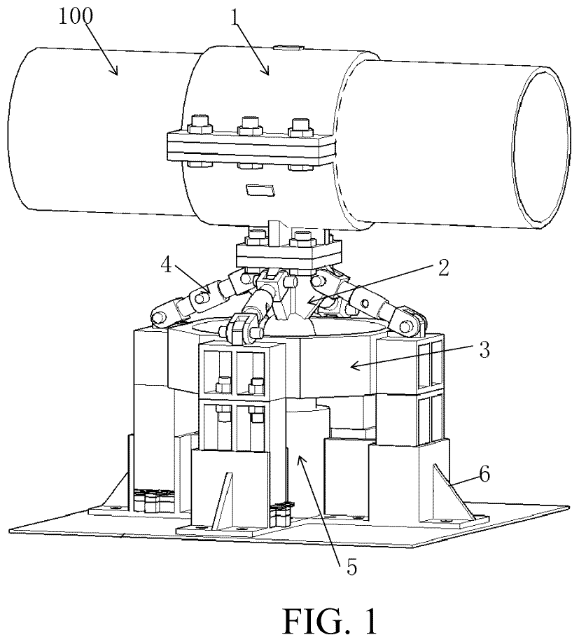

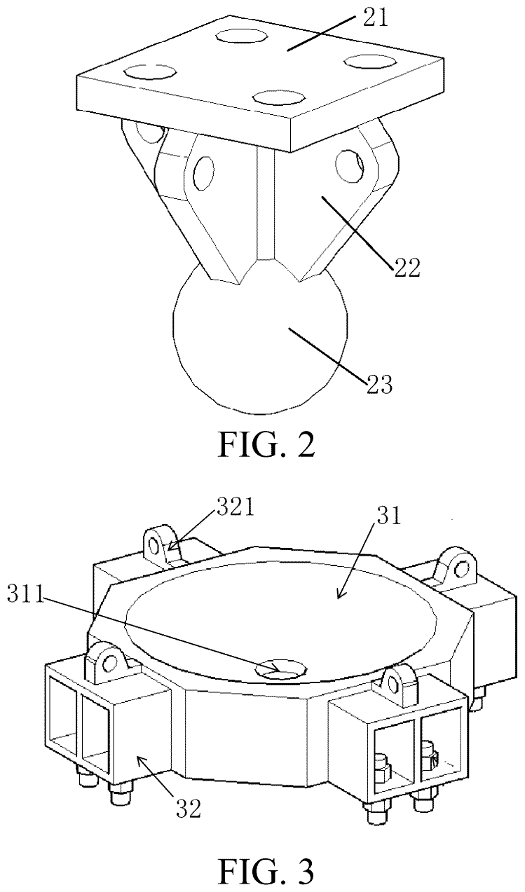

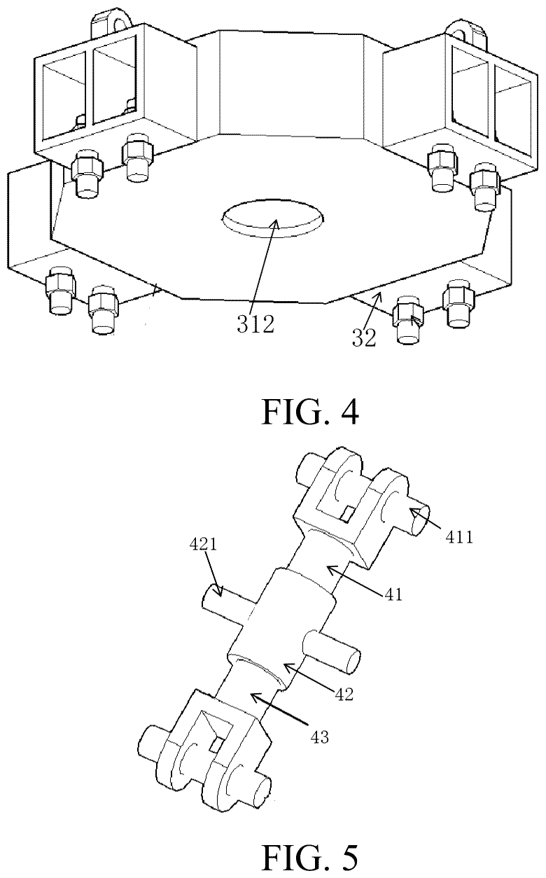

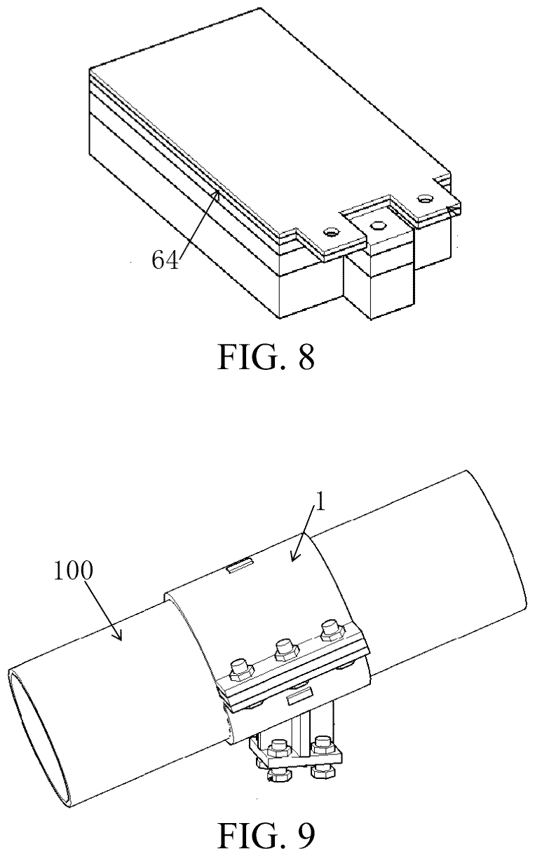

As shown in FIG. 1 to FIG. 9;

A fixture suitable for installation and uninstallation of large steel structures, comprising a limit adapter component I used to support and fix steel structures 100, a spherical sliding device 2 connected with the limit adapter component 1, a locking device 3 provided with an arc-shaped groove 31, an inclined strut 4 whose two ends are hinged with the locking device 3 and the spherical sliding device respectively, a jacking mechanism 5 installed at the bottom of the locking device 3, and a gasket adjustment unit 6 located outside the jacking mechanism 5 and abutted with the bottom of the locking device 3.

In use, the steel structures 100 are first connected with the limit adapter component 1, and the spherical sliding device 2 is connected with the bottom of the limit adapter component 1; the above connecting structure is lifted to the designated position of the locking device 3, and the spherical sliding device is controlled to move into the arc-shaped groove 31, and move in the arc-shaped groove 31 to the bottom position of the arc-shaped groove 31; when the device is stable, the spherical sliding device and locking device 3 are hinged through the inclined strut 4, in order to achieve temporary fixation;

After the steel structure 100 is assembled, the bottom of the locking device will be jacked by a jacking mechanism 5 during each stage of uninstallation, so that the locking device 3 moves towards the side away from the gasket adjustment unit 6, achieving separation between the two; according to the uninstallation amount at each point, the corresponding gasket adjustment unit 6 is replaced, and the jacking mechanism 5 is controlled to fall back; after safety is confirmed, the next unstallation step is performed until the uninstallation is completed.

In some possible implementations, in order to effectively realize installation of steel structures 100,
the limit adapter component 1 comprises an installation component used to install steel structures 100, and a connecting web plate used to connect with the installation component.
the bottom of the connecting web plate is connected with the top of the spherical sliding device 2.

When the steel structure 100 is cylindrical, the installation component comprises two arc-shaped installation plates that form a cylindrical chamber. In order to avoid sliding of the steel structure 100 after installation in the cylindrical chamber, a limit hole is provided on the arc-shaped installation plate; a limit protrusion is provided on the steel structure 100, and the axial movement of the steel structure 100 along the cylindrical chamber is avoided through the fit of the limit protrusion and the limit hole;

When the steel structure 100 is another component with a flat bottom plate structure, the installation component will be a flat plate structure, which can be connected to the flat bottom structure of the component;

When the steel structure 100 needs to be installed at an angle, the end of the connecting web plate close to the installation component should also be set at an angle, and the angles of inclination of the two should be consistent.

In some possible implementations, in order to effectively realize sliding fit between the spherical sliding device 2 and the arc-shaped groove 31, and reduce the sliding friction force,
the spherical sliding device 2 comprises an adapter plate 21 connected with the limit adapter component 1, an ear plate 22 installed on the adapter plate 21 and hinged with the inclined strut 4, and a sliding ball 23 connected with the end of the ear plate 22 away from the adapter plate 21.

By sliding the sliding ball 23 in the arc-shaped groove 31 and providing effective support to the steel structure 100 and the limit adapter component 1 during the sliding process, the fit between the sliding ball 23 and the arc-shaped groove 31 will reduce the friction force between the spherical sliding device 2 and the locking device 3 during the sliding process;

Furthermore, lubricating oil is coated inside the arc-shaped groove 31 to further reduce the sliding friction force.

In some possible implementations, in order to effectively realize connection between the inclined strut 4 and the locking device 3,
the locking device 3 comprises a locking body with an arc-shaped groove 31 and a connecting lug 32 arranged outside the locking body; and the end of the inclined strut 4 far from the spherical sliding device 2 is hinged with the connecting lug 32.

In order to effectively limit the position of the sliding ball 23 end in the arc-shaped groove 31 and avoid sliding after assembly,
the arc-shaped groove 31 is a spherical crown groove, and a limit groove 311 connected therewith is provided at the bottom of the arc-shaped groove 31.

When the sliding ball 23 slides to the bottom of the arc-shaped groove 31, some or all of it will be located in the limit groove 311, so that when the sliding ball 23 slides into the limit groove, the sliding ball 23 no longer has the sliding ability, playing a role in locking the sliding ball 23;

In some possible implementations, in order to effectively realize temporary fixation between the spherical sliding device 2 and the locking device 3,
there are multiple sets of inclined struts 4, and the connecting lug 32 is provided with a support lug 321 hinged with the inclined strut 4; the inclined strut 4 comprises an upper lead screw 41 hinged with the ear plate 22, a lower lead screw 43 connected with the support lug 321, and sleeves 42 connected with the upper lead screw 41 and the lower lead screw 43 respectively; threads are provided outside the upper lead screw 41 and the lower lead screw 43, and the two sets of threads rotate in opposite directions.

Preferably, as shown in FIG. 1, there are four sets of inclined struts 4 to temporarily fix the spherical sliding device 2 and the locking device 3; at this time, there are also four sets of support lugs 321 provided on the connecting lug 32; the support lugs 321 will be uniformly arranged along the circumference of the opening end of the arc-shaped groove 31;

The upper lead screw 41 and the lower lead screw 43 are connected together through the sleeve 42. When the sleeve 42 is connected, the screw-in lengths of the upper lead screw 41 and the lower lead screw 43 are basically the same. At the same time, the engagement length of the two lead screws with the sleeve 42 meets the minimum bearing capacity requirements. The connection between the inclined strut 4 and the spherical sliding device 2, locking device 3 is achieved through connecting the pin roll outside the lead screw with the ear plate 22, and the connection with the spherical sliding device 2, locking device 3 can be locked or loosened through rotating the handle 421 provided outside the sleeve 42; the inclined strut 4 is used to fix and lock the steel structure 100 after the steel structure 100 is accurately in place and before the uninstallation is completed, playing the role of temporary fixation.

In some possible implementations, in order to effectively realize uninstallation,
the gasket adjustment unit 6 comprises a support platform 61, an installation part 62 installed on the support platform 61 and provided with an installation groove 621, multiple sets of stacked gaskets 64 with different thicknesses, and a support adapter 63 installed above the gasket 64 and connected with the connecting lug 32; the gasket 64 is installed in the installation groove 621.

Gaskets 64 with different thicknesses are installed in the installation groove 621, so that during uninstallation, some or all of the gaskets 64 can be removed from the installation groove 621 according to the uninstallation amount requirements, thereby meeting the uninstallation requirements;

If the gaskets 64 include such specifications as 20 mm, 10 mm, 5 mm, 3 mm, 2 mm, and 1 mm, when the uninstallation amount is 5 mm, the 5 mm gasket 64 can be directly removed, or one 2 mm gasket 64 and one 3 mm gasket 64 may be removed. Also, three 1 mm gaskets 64 and one 2 mm gasket 64 may be removed to achieve the uninstallation amount of 5 mm;

Furthermore, the base plate comprises a plate body and a small ear plate 22 integrated with the plate body, and the provision of the small ear plate 22 makes replacement more convenient;

In some possible implementations, in order to support steel structures 100 more stably,
there are multiple sets of the support adapters 63, connecting lugs 32, and installation parts 62, provided one-to-one correspondingly; an installation chamber is formed inside the multiple set of installation parts 62 for installing the jacking mechanism 5.

In some possible implementations, the installation groove 621 is of U-shaped structure, and its opening is provided on the flank of the installation part 62.

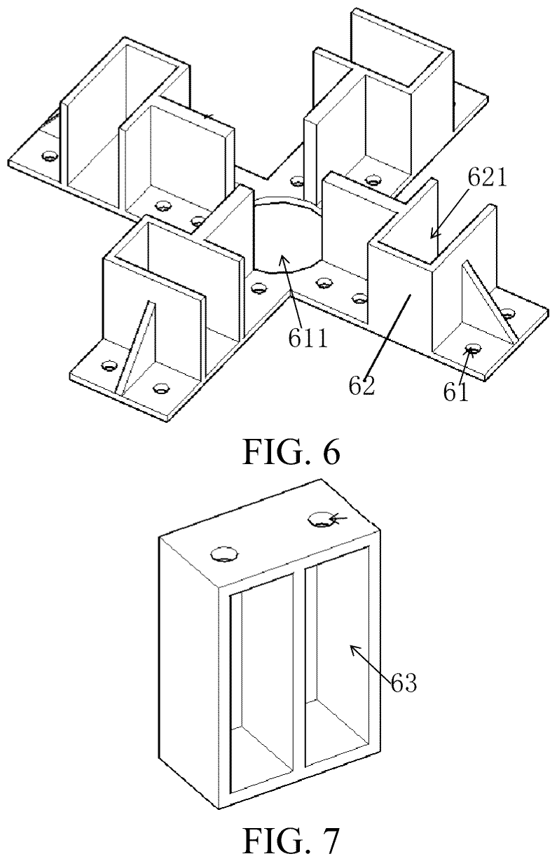

The opening of the installation groove 621 is provided mainly to ensure the removal of the gasket 64 during the uninstallation process, as shown in FIG. 6. The opening is provided on the flank to avoid removing the gasket 64 from between the support adapter 63 and the bottom of the support platform;

Preferably, the depth of the installation groove 621 will be greater than the overall height of the gasket 64, and the support adapter 63 will be partially located inside the installation groove 621. This provision will avoid the horizontal movement of the support adapter 63 and limit it;

In some possible implementations, a limit groove A 611 for installing the jacking mechanism 5 is provided on the support platform 61, and a limit groove B 312 coaxial with the limit groove A 611 is provided on the locking body.

The limit groove A 611 and limit groove B 312 are provided mainly to position the jacking mechanism 5. The output end of the jacking mechanism 5 will extend into the limit groove B 312, and the lower part will be located in the limit groove A 611 to prevent the jack from overturning, while ensuring that the jacking mechanism 5 is on the same axis as the jacking position.

Furthermore, the jacking mechanism 5 in the present invention can be existing products such as jacks, hydraulic cylinders, cylinders; its internal structure will not be elaborated here.

On the other hand:

A construction method of a fixture suitable for installation and uninstallation of large steel structures 100 specifically comprises the following steps:
step S1: connecting steel structures 100 with the limit adapter component 1;
step S2: lifting, and positioning the spherical sliding device 2 in the arc-shaped groove 31, temporarily fixing the spherical sliding device 2 and locking device 3 through the inclined strut 4, and assembling the steel structures 100; specifically comprising the following steps:
step S21: lifting, controlling the sliding ball 23 to slide in the arc-shaped groove 31, and sliding into the limit groove;
step S22: twisting the sleeve 42 and adjusting the position relationship between the upper lead screw 41 and the lower lead screw 43 to temporarily fix the spherical sliding device 2 and locking device 3;
step S23: assembling the steel structures 100.
step S3: uninstallation;
step S31: jacking the locking device 3 upwards by the jacking mechanism 5 and driving steel structures to move upwards, and removing the gasket 64 according to the uninstallation amount;
step S32: controlling the jacking mechanism 5 to drive the steel structures downwards and continuing to unload until the uninstallation is completed.

The present invention is not limited to the detailed description of the preferred embodiments mentioned above. The present invention expands to any new feature or any new combination disclosed in the Description, and steps in any new method or process or any new combination disclosed.

1. A fixture suitable for installation and uninstallation of large steel structures, characterized by, comprising a limit adapter component used to support and fix steel structures, a spherical sliding device connected with the limit adapter component, a locking device provided with an arc-shaped groove, an inclined strut whose two ends are hinged with the locking device and the spherical sliding device respectively, a jacking mechanism installed at the bottom of the locking device, and a gasket adjustment unit located outside the jacking mechanism and abutted with the bottom of the locking device.

2. The fixture suitable for installation and uninstallation of large steel structures according to claim 1, characterized in that, the limit adapter component comprises an installation component used to install steel structures, and a connecting web plate used to connect with the installation component.

3. The fixture suitable for installation and uninstallation of large steel structures according to claim 2, characterized in that, the spherical sliding device comprises an adapter plate connected with the limit adapter component, an ear plate installed on the adapter plate and hinged with the inclined strut, and a sliding ball connected with the end of the ear plate away from the adapter plate.

4. The fixture suitable for installation and uninstallation of large steel structures according to claim 1, characterized in that, the locking device comprises a locking body with an arc-shaped groove and a connecting lug arranged outside the locking body; and the end of the inclined strut far from the spherical sliding device is hinged with the connecting lug.

5. The fixture suitable for installation and uninstallation of large steel structures according to claim 4, characterized in that, the arc-shaped groove is a spherical crown groove, and a limit groove is provided at the bottom of the arc-shaped groove.

6. The fixture suitable for installation and uninstallation of large steel structures according to claim 4, characterized in that, there are multiple sets of inclined struts, and the connecting lug is provided with a support lug hinged with the inclined strut; the inclined strut comprises an upper lead screw hinged with the ear plate, a lower lead screw connected with the support lug, and sleeves connected with the upper lead screw and the lower lead screw respectively; threads are provided outside the upper lead screw and the lower lead screw, and the two sets of threads rotate in opposite directions.

7. The fixture suitable for installation and uninstallation of large steel structures according to claim 4, characterized in that, the gasket adjustment unit comprises a support platform, an installation part installed on the support platform and provided with an installation groove, multiple sets of stacked gaskets with different thicknesses, and a support adapter installed above the gasket and connected with the connecting lug; the gasket is installed in the installation groove.

8. The fixture suitable for installation and uninstallation of large steel structures according to claim 7, characterized in that, there are multiple sets of the support adapters, connecting lugs, and installation parts, provided one-to-one correspondingly; an installation chamber is formed inside the multiple set of installation parts for installing the jacking mechanism.

9. A construction method of the fixture suitable for installation and uninstallation of large steel structures according to claim 1, characterized by specifically comprising the following steps:
step S1: connecting steel structures with the limit adapter component;
step S2: lifting, and positioning the spherical sliding device in the arc-shaped groove, temporarily fixing the spherical sliding device and locking device through the inclined strut, and assembling the steel structures;
step S3: uninstallation;
step S31: jacking the locking device upwards by the jacking mechanism and driving steel structures to move upwards, and removing the gasket according to the uninstallation amount; and
step S32: controlling the jacking mechanism to drive the steel structures downwards and continuing to unload until the uninstallation is completed.

10. The construction method of the fixture suitable for installation and uninstallation of large steel structures according to claim 9, characterized in that, the step S2 specifically comprises the following steps:
step S21: lifting, controlling the sliding ball to slide in the arc-shaped groove, and sliding into the limit groove;
step S22: twisting the sleeve and adjusting the position relationship between the upper lead screw and the lower lead screw to temporarily fix the spherical sliding device and locking device; and
step S23: assembling the steel structures.
